(19) United States
(12) Patent Application Publication
(10) Pub. No.: US 2016/0320583 A1
(43) Pub. Date: Nov. 3, 2016

(54) VIRTUAL IMAGE MASK FOR SMARTWATCHES

(71) Applicant: FLOYD STEVEN HALL, JR., Sacramento, CA (US)

(72) Inventor: FLOYD STEVEN HALL, JR., Sacramento, CA (US)

(21) Appl. No.: 14/701,271

(22) Filed: Apr. 30, 2015

(51) Int. Cl. G02B 7/00; G04G 17/04; G02B 3/04; G02B 5/32; G06F 1/16; G02B 25/00

(52) U.S. Cl. CPC G02B 7/002; G06F 1/163; G06F 1/1601; G02B 25/002; G02B 3/04; G02B 5/32; G02B 25/001; G04G 17/045

(57) ABSTRACT

Using this invention, smartwatches can provide a big screen viewing experience.

### FIELD OF INVENTION

This invention relates to smartwatches.

### DESCRIPTION OF PRIOR ART

At present, a smartwatch has not gained widespread acceptance with mainstream consumers. The reason is because no software applications, developed to run on said smartwatch, are compelling enough to drive widespread acceptance of said smartwatch with mainstream consumers. Said smartwatch typically has an operating system, and can include one or a plurality of programmable interfaces, such as an Application Program Interface (API), or Application Binary Interface (ABI), used by programmers to develop software applications to run on said smartwatch. See Soper, Taylor, “Smartwatch market still tiny, needs killer app”, GeekWire, Jan. 5, 2014; and Seitz, Patrick, “Smartwatches still searching for killer app”, Investors.com, Jan. 8, 2015.

One possible solution is to enable said smartwatch to run compelling software applications developed to run on a device other than said smartwatch. One of many possible examples is said smartwatch running Microsoft Windows software applications, developed to run on an Intel-based personal computer. Virtualization software, developed to run on said smartwatch, can enable said smartwatch to run software applications developed for a plurality of devices, where a device within said plurality of devices can include: a desktop computer, a laptop computer, a tablet computer, a wearable computer, a smartphone, an eReader, a television, a game console, and a media player. Refer to companies such as VMware, Citrix, and Microsoft, for a further discussion of virtualization software.

Although said smartwatch can be enabled to run software applications developed to run on a device other than said smartwatch, said smartwatch also should be enabled to display a viewing experience comparable to said device other than said smartwatch.

This invention has been created to enhance said viewing experience provided by said smartwatch.

### SUMMARY OF THE INVENTION

One embodiment of the invention is a virtual image mask for holding a virtual image means close enough to a display means on a smartwatch, so that a magnified virtual image is formed of sufficient size to accommodate use by a human being for viewing and working with software applications developed to run on desktop and laptop computers, when held near eye. In one of many possible embodiments, said virtual image mask includes said virtual image means. In another of many possible embodiments, said virtual image mask can be secured to a headwear means.

Said virtual image means is a magnifier that is capable of forming a magnified virtual image of an image source where, in this invention, said image source is said display means on said smartwatch. Some of many possible embodiments of said virtual image means are a convex lens, a Fresnel lens, and a holographic lens. One embodiment discussed is said virtual image mask secured to said smartwatch using watch pins, and secured to said headwear means using a pivotal attachment. Another embodiment discussed is said virtual image mask secured to an Apple smartwatch using Apple clasp attachments, and secured to said headwear means using a pivotal attachment. An additional embodiment discussed is said virtual image mask when said virtual image means either is said display means on said smartwatch, or is directly attached to said display means on said smartwatch.

### SUMMARY OF FIGURES

FIG. 1 illustrates a virtual image mask, with virtual image means, providing a big screen viewing experience.

FIG. 2 illustrates a head mounting means, which is one embodiment of a headwear means, which attaches to a virtual image mask.

FIG. 3 illustrates a nose mounting means, which is another embodiment of a headwear means, which attaches to a virtual image mask.

FIG. 4 illustrates the top view, side view, and front view of a virtual image mask using watch pin attachments.

FIG. 5 illustrates a perspective view for a virtual image mask using watch pin attachments, with a headwear attachment.

FIG. 6 illustrates a perspective view for a virtual image mask using watch pin attachments, with no headwear attachment.

FIG. 7 illustrates attaching a virtual image means, a virtual image mask, a smartwatch, and a headwear means.

FIG. 8 illustrates the top view, side view, and front view of a virtual image mask using Apple clasp attachments.

FIG. 9 illustrates a perspective view of a virtual image mask using Apple clasp attachments, with a headwear attachment.

FIG. 10 illustrates a perspective view of a virtual image mask using Apple clasp attachments, with no headwear attachment.

FIG. 11 illustrates a perspective view of a virtual image mask using an Apple clasp attachment, when a virtual image means is the display means or directly attached to the display means on said smartwatch.

FIG. 12 illustrates how to attach virtual image mask onto an Apple smartwatch.

FIG. 13 illustrates a virtual image mask, with a virtual image means, attached to an Apple smartwatch.

### DETAILED DESCRIPTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the invention. Thus, the invention is not intended to be limited to the embodiments disclosed, but is to be accorded the widest scope consistent with the principles and features disclosed herein.

The invention is based on the following insight:

Said smartwatch is capable of running desktop software applications, but does not provide the big screen viewing experience of a desktop display.

One embodiment of the invention is a virtual image mask, comprising:
a. a support means for holding a virtual image means, and
b. an attachment means for securing said support means to a smartwatch, said smartwatch having a display means,

whereby said support means can hold said virtual image means close enough to said display means, so that a magnified virtual image is formed of sufficient size to accommodate use by a human being for viewing and working with software applications developed to run on desktop and laptop computers, when said support means with said smartwatch attached is held near eye.

One of many possible embodiments of said virtual image mask further includes an attachment means for securing said support means to a headwear means. Another of many possible embodiments of said virtual image mask further includes said virtual image means.

Said virtual image mask can be made of one or a plurality of materials. In one embodiment, said virtual image mask is made of one or a plurality of materials that are lightweight, with a high strength-to-weight ratio, such as structural foam, graphene, or appropriate plastics. In another embodiment, said virtual image mask is made of one or a plurality of materials that are precious metals, resulting in said virtual image mask being regarded as jewelry. In yet another embodiment, said virtual image mask is made of transparent materials. In still another embodiment, said virtual image mask is made of a magnetic material. In yet another embodiment, said virtual image mask is made of a transparent magnetic material. See Ziolo, Ronald, “See-Through Magnets—Value of the First Step”, R&D Innovator Volume 3, Number 11 (November 1994); and Pennisi, Elizabeth, “Nanotechnology yields transparent magnet—tiny iron oxide particles become more transparent than in bulk form”, Sciences Services Group (1992).

Said virtual image means is a magnifier that is capable of forming a magnified virtual image of an image source where, in this invention, said image source is a display means on said smartwatch. Said magnified virtual image is formed when the separation distance, between said virtual image means and said display means on said smartwatch, is less than the focal length of said virtual image means.

One of many possible embodiments of said virtual image means is a convex lens. Another embodiment of said virtual image means is a Fresnel lens. An additional embodiment of said virtual image means is a holographic lens. Still another embodiment of said virtual image means is an eyepiece. Yet another embodiment of said virtual image means is a projection lens system. One more embodiment of said virtual image means is a vision-correcting display means on said smartwatch, where a new use for the vision-correcting software running on said smartwatch is to enable said vision-correcting display means to form said magnified virtual image, i.e. said magnified virtual image is software-configurable. See Hecht, Eugene (2002), Optics (4th ed.), Addison Wesley ISBN 0-321-18878-0; Greivenkamp, John E. (2004), Field Guide to Geometrical Optics, SPIE Field Guides vol. FG01, SPIE. ISBN 0-8194-5294-7; Carson, Fred A. (1969), Basic Optics and Optical Instruments, U.S. Navy Bureau of Naval Pe.; Cox, A., “Application Of Fresnel Lenses To Virtual Image Display”, Proc. SPIE 0162, Visual Simulation and Image Realism I, 130 (Dec. 22, 1978); and Hardesty, L., “Vision-correcting displays”, MIT News, Jul. 31, 2014.

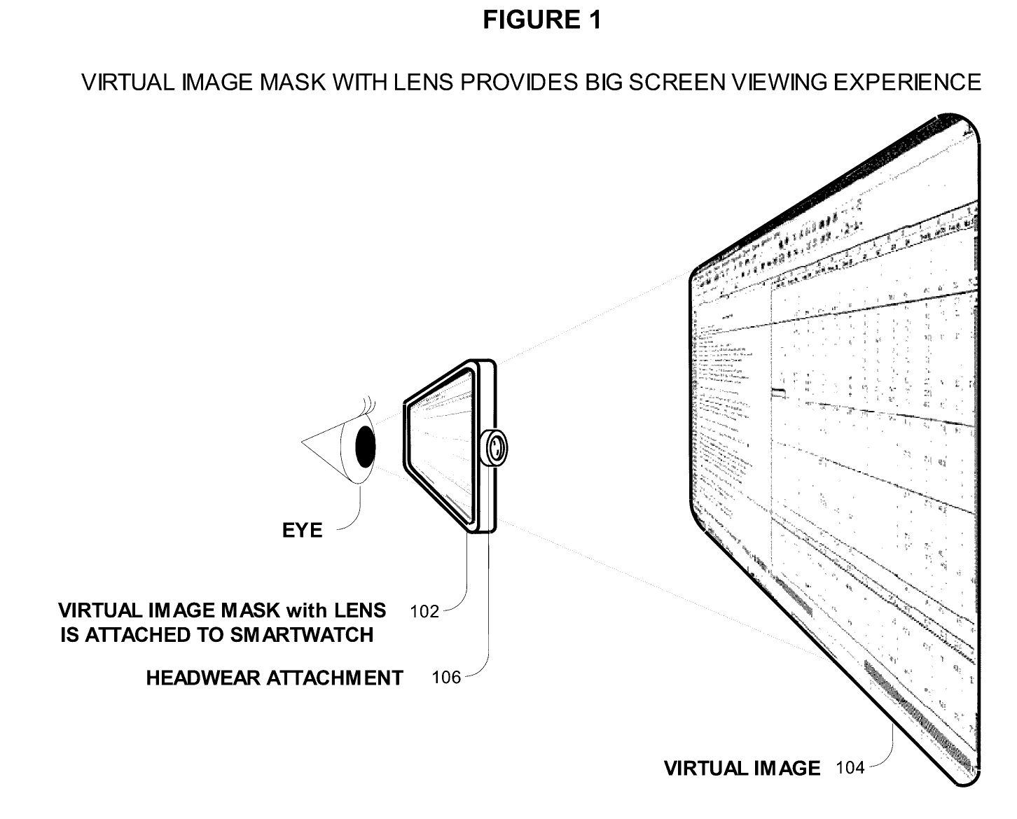

As illustrated in FIG. 1, said virtual image mask 102, with said virtual image means included, magnifies said display means on said smartwatch, to form said magnified virtual image 104, where said magnified virtual image 104 provides a virtual big screen viewing experience for said smartwatch. Said virtual image mask 102 includes an attachment means 106 for securing said virtual image mask 102 to a headwear means. A plurality of embodiments of said headwear means are possible. Vendors of said headwear include Plantronics, Vuzix, and Kopin.

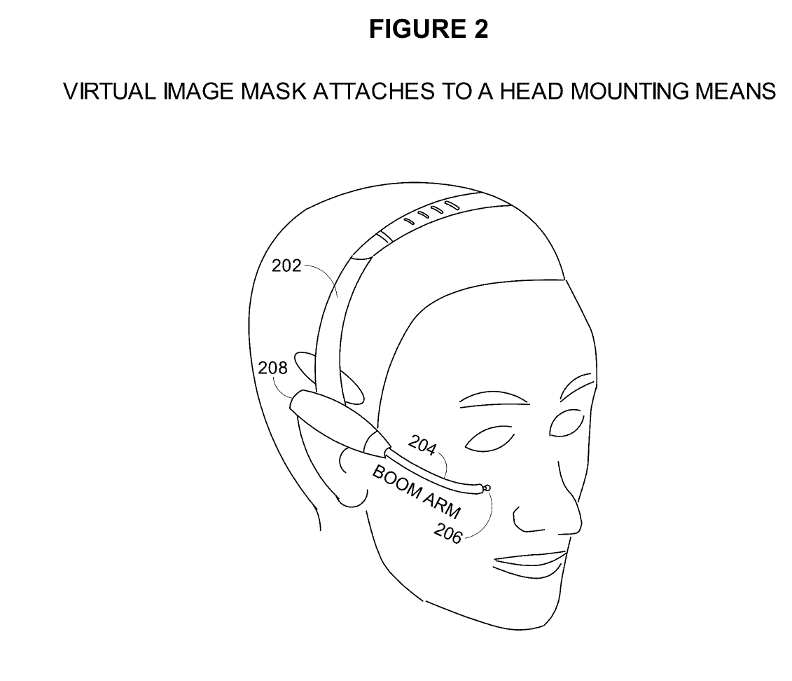

FIG. 2 illustrates a head mounting means 202, where said head mounting means 202 is one embodiment of said plurality of embodiments of said headwear means. Said head mounting means 202 includes an adjustable boom arm 204, where said boom arm 204 includes an attachment means 206 for securing said virtual image mask 102 to said head mounting means 202. Said attachment means 206 connects with said attachment means 106, to secure said virtual image mask 102 to said head mounting means 202. A sleeve 208 can, if desired, contain a pivotal attachment, and can, if desired, enable said boom arm 204 to retract into said sleeve 208.

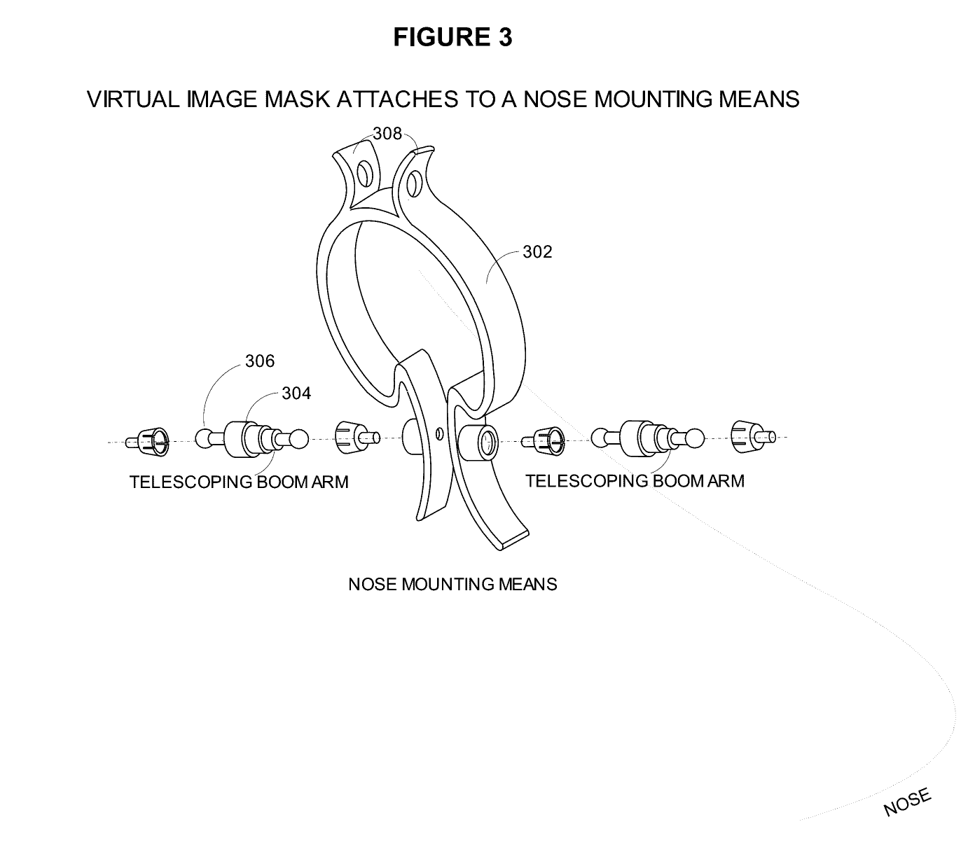

FIG. 3 illustrates a nose mounting means 302, where said nose mounting means 302 is another embodiment of said plurality of embodiments of said headwear means. Said nose mounting means 302 includes an adjustable boom arm 304, where said boom arm 304 includes an attachment means 306 for securing said virtual image mask 102 to said nose mounting means 302. Said attachment means 306 connects with said attachment means 106, to secure said virtual image mask 102 to said nose mounting means 302. Said nose mounting means 302 can support one said virtual image mask 102, for monocular viewing, or support two of said virtual image mask 102, for binocular viewing.

To don and remove said nose mounting means 302, fingerpieces 308 are squeezed and released, using two fingers on one hand. Said nose mounting means 302, which is a modified pince nez nose bridge mounting, applies pressure to squeeze or pinch the bridge of the nose, to keep said nose mounting means secured to said nose. Pince nez eyeglasses, which use pince nez nose bridge mountings, were popular in America from the mid-19^{th} to mid-20^{th} centuries, symbolized money and status, and represented the cutting edge of fashion. Indeed, pince nez nose bridge mountings were made occasionally of precious metals, and considered as jewelry. Refer to U.S. patent application Ser. No. 14/512,419 by Floyd S. Hall, Jr. Many other embodiments of said plurality of embodiments of said headwear means, not illustrated here, are possible. For example, eyeglasses, goggles, helmets, hats, eye-patches, ear-clips, head bands, etc. are additional embodiments of said plurality of embodiments of said headwear means, in accordance with the invention, and not illustrated here.

In one detailed embodiment of said virtual image mask discussed here, a watch pin is said attachment means for securing said support means to said smartwatch, where said support means is a frame, and further including an attachment means for securing said frame to said headwear means, where said attachment means for securing said frame to said headwear means is a pivotal attachment. This embodiment of said virtual image mask is referred to here as a virtual image mask using watch pin attachments.

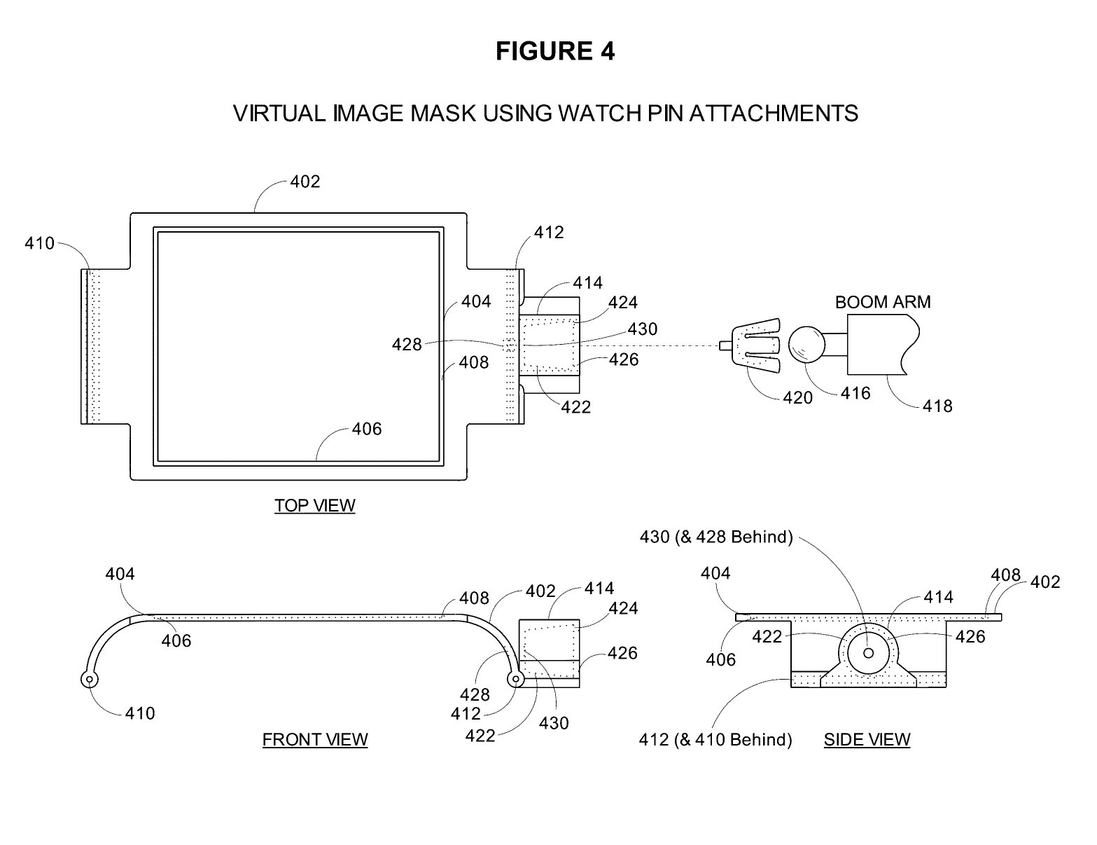

FIG. 4 illustrates the top view, front view, and side view of said virtual image mask using watch pin attachments. Said frame 402 that contains a receptacle 404 for holding said virtual image means can contain a cutout area, or a plurality of cutout areas. Said cutout area can be used to enable either or both of said attachment means, or said cutout area can coincide with a feature on said smartwatch that would perform better unencumbered by said frame 402. Said feature on said smartwatch can include: a display means, a camera, a microphone, a speaker, an antenna, a mechanical button, a mechanical wheel, a port, and a recharging area.

Said receptacle 404 includes a display cutout 406 that coincides with said display means on said smartwatch, and where said receptacle 404 is larger than said display cutout 406, so that a retaining lip 408 is created. Said virtual image means fits inside said receptacle 404, and is supported by said retaining lip 408. Said frame 402 includes a watch pin cutout 410, and a watch pin cutout 412. To secure said frame 402 to said smartwatch, said watch pin is used. To secure said frame 402 to said headwear means, said pivotal attachment is used. A female component 414 of said pivotal attachment is integrated with said frame 402, and a male component 416 of said pivotal attachment is integrated with said boom arm 418 on said headwear means. A locking gasket 420 is used to lock said male component 416 into said female component 414, thus securing said frame 402 to said headwear means. Said locking gasket 420 also serves as a bearing for said pivotal attachment.

Said female component 414 contains a slightly tapered internal surface 422 that enables a snug fit for said locking gasket 420. Said female component 414 is recessed to create a retaining lip 424. After said locking gasket 420 is pushed onto said male component 416, then said male component 416 along with said locking gasket 420 are both pushed through entrance 426 into said female component 414, past said retaining lip 424, allowing said locking gasket 420 to expand just enough (behind said retaining lip 424) to lock said male component 416 into said female component 414. The result is a locked pivotal attachment, created using said male component 416, said locking gasket 420, and said female component 414. Said locked pivotal attachment can be unlocked by pushing on the small end of said locking gasket 420, through an unlocking cutout 428 and through opening 430. Refer to patents U.S. Pat. No. 5,076,701 and U.S. Pat. No. 4,603,944 for a further discussion of said pivotal attachment discussed here. Note, however, that the invention can use a plurality of different said attachment means for securing said frame 402 to said headwear means.

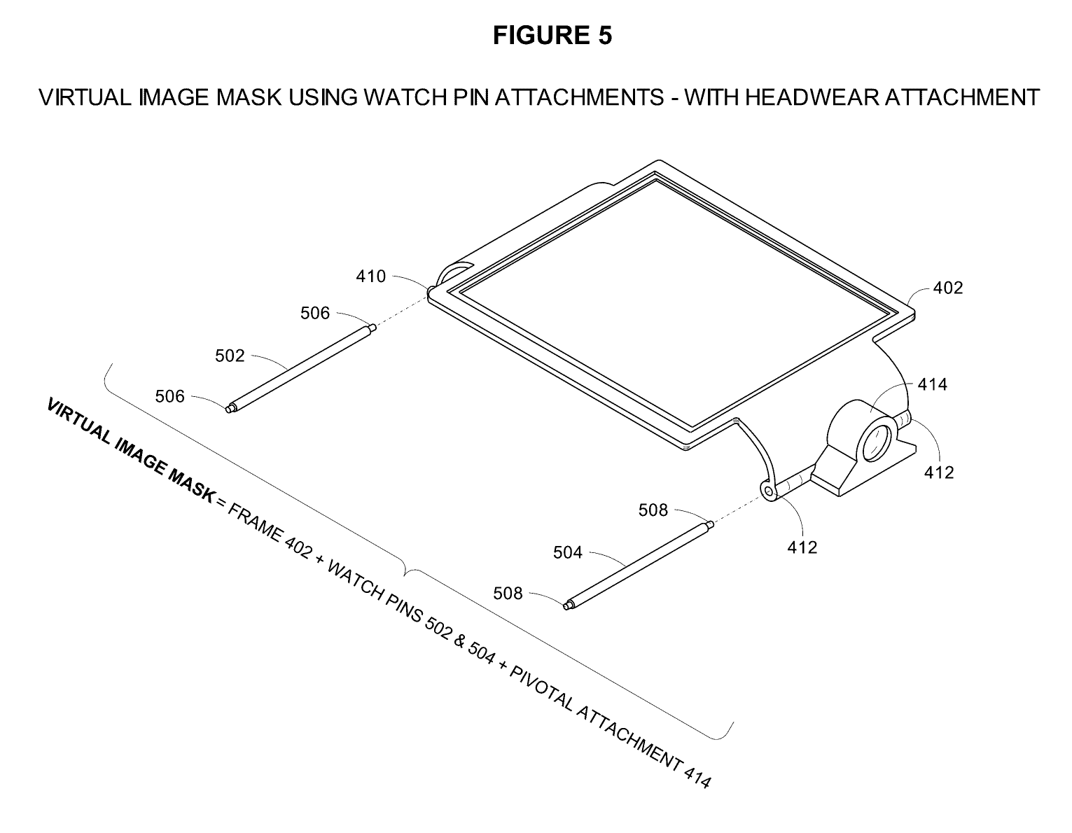

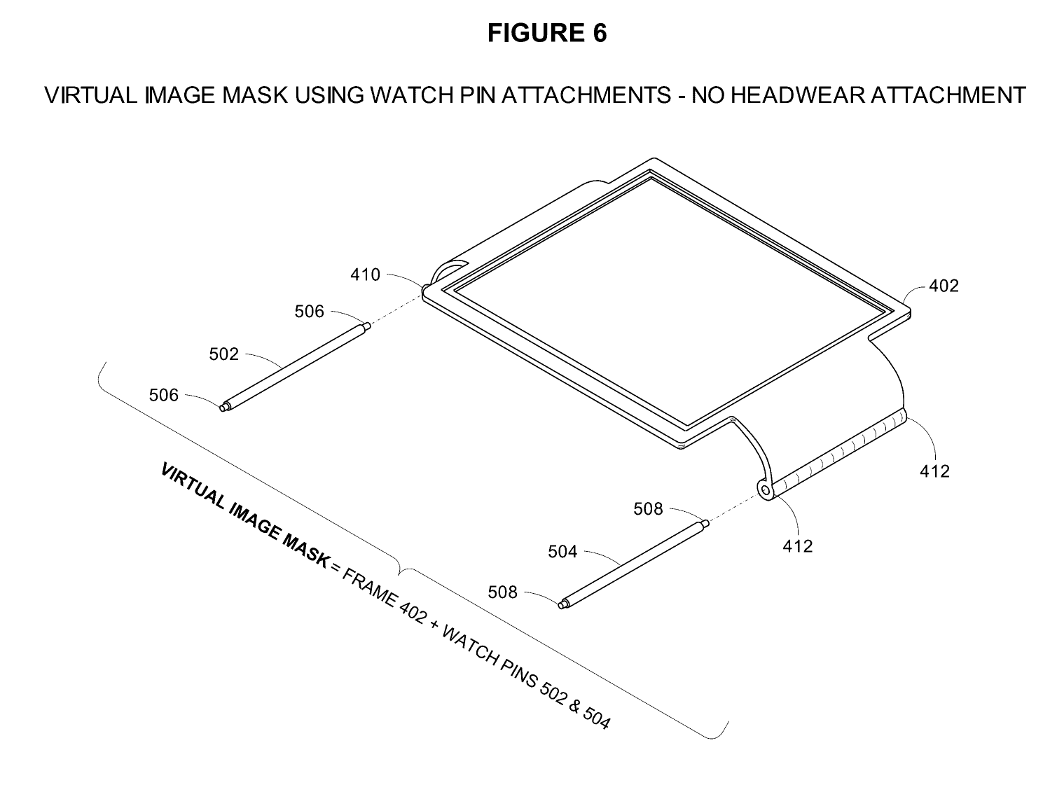

FIG. 5 illustrates a perspective view of said virtual image mask using watch pin attachments, with a headwear attachment. Said frame 402 contains said receptacle 406 for said virtual image means. To secure said frame 402 to said smartwatch, said watch pin is said attachment means. One said watch pin 502 is inserted into said watch pin cutout 410, and one said watch pin 504 is inserted into said watch pin cutout 412. To secure said frame 402 to said headwear means, said pivotal attachment 414 is said attachment means. FIG. 6 illustrates a perspective view of said virtual image mask using watch pin attachments, with no said headwear attachment.

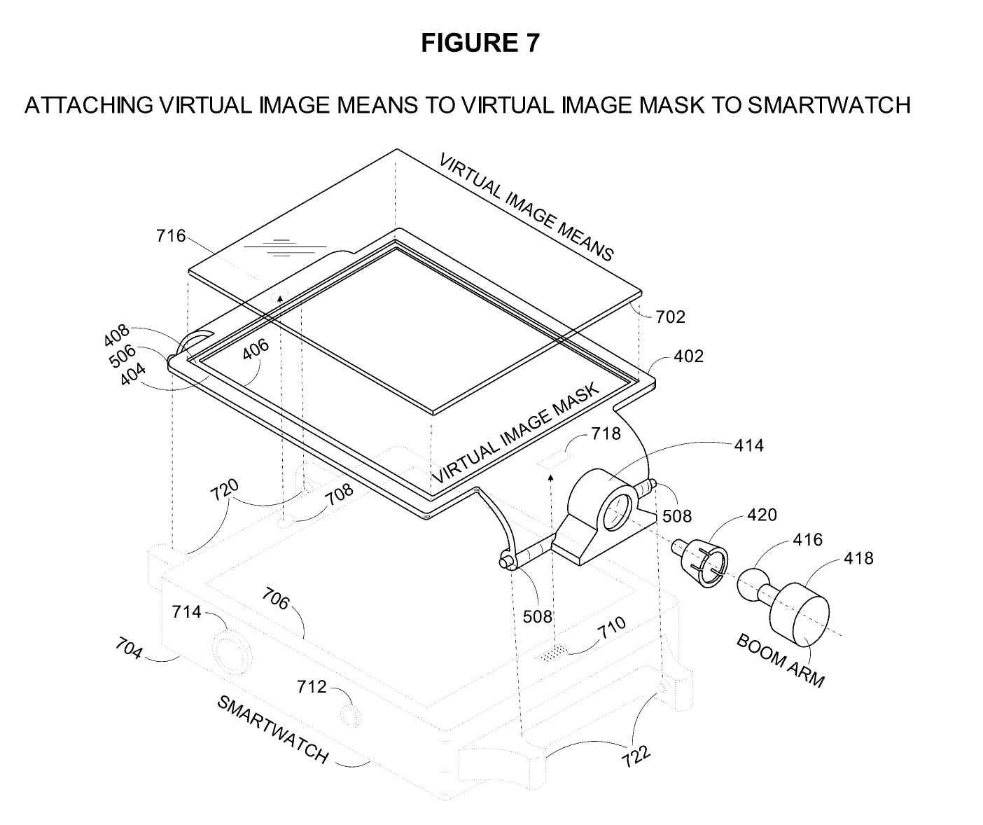

FIG. 7 illustrates attaching said virtual image means, said virtual image mask, said smartwatch, and said headwear means. The shape of said frame 402, the shape of said receptacle 404 for holding said virtual image means 702, and the number of said cutouts contained within said frame 402, can each differ to accommodate different designs of said smartwatch by a vendor of said smartwatch. Said vendor includes Apple, Samsung, Sony, Pebble, LG, and Motorola. An example smartwatch 704 is one of many possible embodiments of said smartwatch, in accordance with the invention. Said example smartwatch 704 has a display means 706, a camera 708, a speaker 710, a microphone 712, and a mechanical wheel 714. For said example smartwatch 704, said frame 402 includes a camera cutout 716 and a speaker cutout 718, in addition to said display cutout 406, to prevent said display means 706, said camera 708, and said speaker 710 from being encumbered by said frame 402.

To secure said virtual image means 702 to said frame 402, said virtual image means 702 is secured to said retaining lip 408 using an adhesive attachment means. Said adhesive attachment means can include a chemical means (such as glue); a mechanical means (such as pressure); an electromagnetic means (such as magnetic attraction, or electrostatic attraction), or any other said adhesive attachment means. In another embodiment, said virtual image means 702 is secured to said retaining lip 408 using a hinge means. To secure said frame 402 to said example smartwatch 704, each end 506 of said watch pin 502 is inserted into a watch pin receptacle 720, and each end 508 of said watch pin 504 is inserted into a watch pin receptacle 722. To secure said frame 402 to said headwear means, said pivotal attachment is used. Said pivotal attachment secures said frame 402 to said headwear means by locking together said male component 416 of said pivotal attachment with said female component 414 of said pivotal attachment, using said locking gasket 420. Said pivotal attachment is integrated with said boom arm 418 on said headwear means. However, other embodiments of said pivotal attachment need not be integrated with said boom arm 418. In an additional embodiment, said frame 402 and said boom arm 418 can be integrated together as one single unit, without said pivotal attachment. Said virtual image means 702 is placed into said receptacle 404, and secured to said retaining lip 408 using said adhesive attachment means.

In another detailed embodiment of said virtual image mask discussed here, a male Apple clasp attachment is said attachment means for securing said support means to said smartwatch, where said support means is a frame for Apple smartwatch, and further including an attachment means for securing said frame for Apple smartwatch to said headwear means, where said attachment means for securing said frame for Apple smartwatch to said headwear means is a pivotal attachment. In this detailed embodiment, said smartwatch is an Apple smartwatch, said male Apple clasp attachment is shown as the top portion of a watch band illustrated in Apple patent U.S. D724,469 S, and a female Apple clasp attachment is integrated with said Apple smartwatch as illustrated in Apple patent U.S. D724,103 S. This embodiment of said virtual image mask is referred to here as a virtual image mask using Apple clasp attachments.

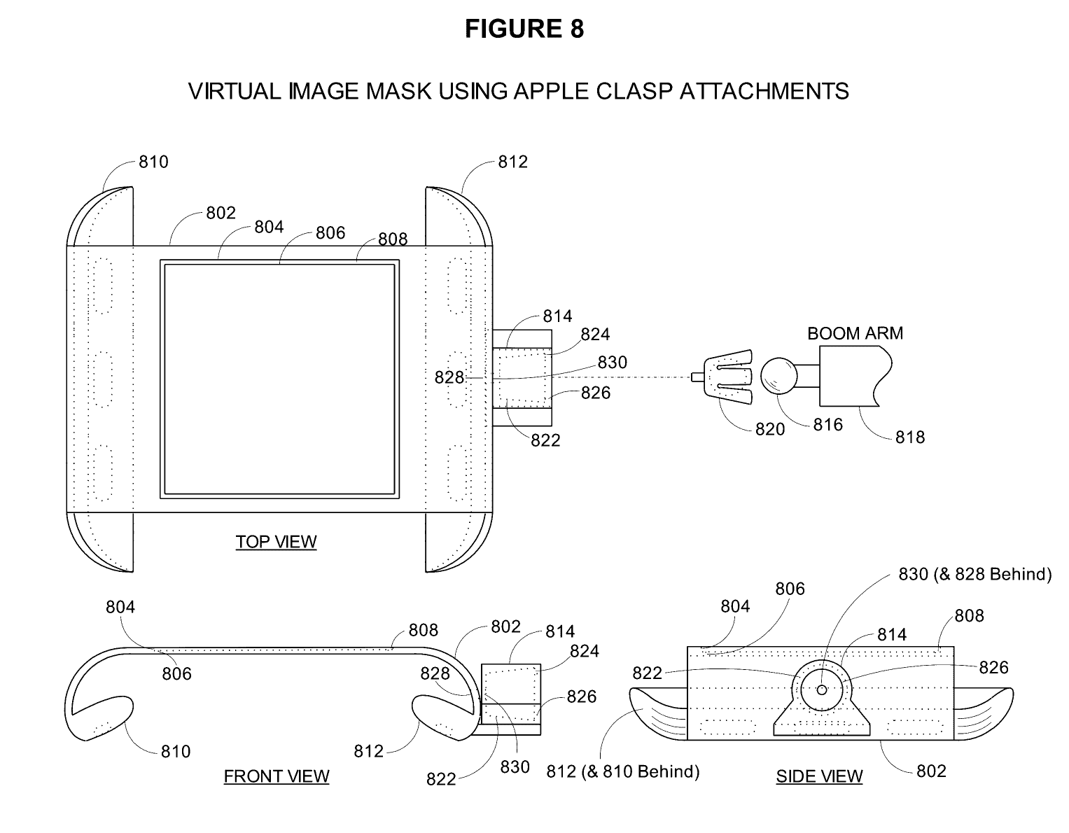

FIG. 8 illustrates the top view, front view, and side view of said virtual image mask using Apple clasp attachments. Said frame for Apple smartwatch 802 that contains a receptacle 804 for holding said virtual image means can contain a cutout area, or a plurality of cutout areas. Said cutout area can coincide with a feature on an Apple smartwatch that would perform better unencumbered by said frame for Apple smartwatch 802. Said feature on said Apple smartwatch can include: a display means, a camera, a microphone, a speaker, an antenna, a mechanical button, a mechanical wheel, a port, and a recharging area.

Said receptacle 804 includes a display cutout 806 that coincides with said display means on said Apple smartwatch, and where said receptacle 804 is larger than said display cutout 806, so that a retaining lip 808 is created. Said virtual image means fits inside said receptacle 804, and is supported by said retaining lip 808. Said frame for Apple smartwatch 802 includes said male Apple clasp attachment 810, and said male Apple clasp attachment 812. To secure said frame for Apple smartwatch 802 to said headwear means, said pivotal attachment is used. A female component 814 of said pivotal attachment is integrated with said frame for Apple smartwatch 802, and a male component 816 of said pivotal attachment is integrated with said boom arm 818 on said headwear means. A locking gasket 820 is used to lock said male component 816 into said female component 814, thus securing said frame for Apple smartwatch 802 to said headwear means. Said locking gasket 820 also serves as a bearing for said pivotal attachment.

Said female component 814 contains a slightly tapered internal surface 822 that enables a snug fit for said locking gasket 820. Said female component 814 is recessed to create a retaining lip 824. After said locking gasket 820 is pushed onto said male component 816, then said male component 816 along with said locking gasket 820 are both pushed through entrance 826 into said female component 814, past said retaining lip 824, allowing said locking gasket 820 to expand just enough (behind said retaining lip 824) to lock said male component 816 into said female component 814. The result is a locked pivotal attachment, created using said male component 816, said locking gasket 820, and said female component 814. Said locked pivotal attachment can be unlocked by pushing on the small end of said locking gasket 820, through an unlocking cutout 828 and through opening 830. Refer to patents U.S. Pat. No. 5,076,701 and U.S. Pat. No. 4,603,944 for a further discussion of said pivotal attachment discussed here. Note, however, that the invention can use a plurality of different said attachment means for securing said frame for Apple smartwatch 802 to said headwear means.

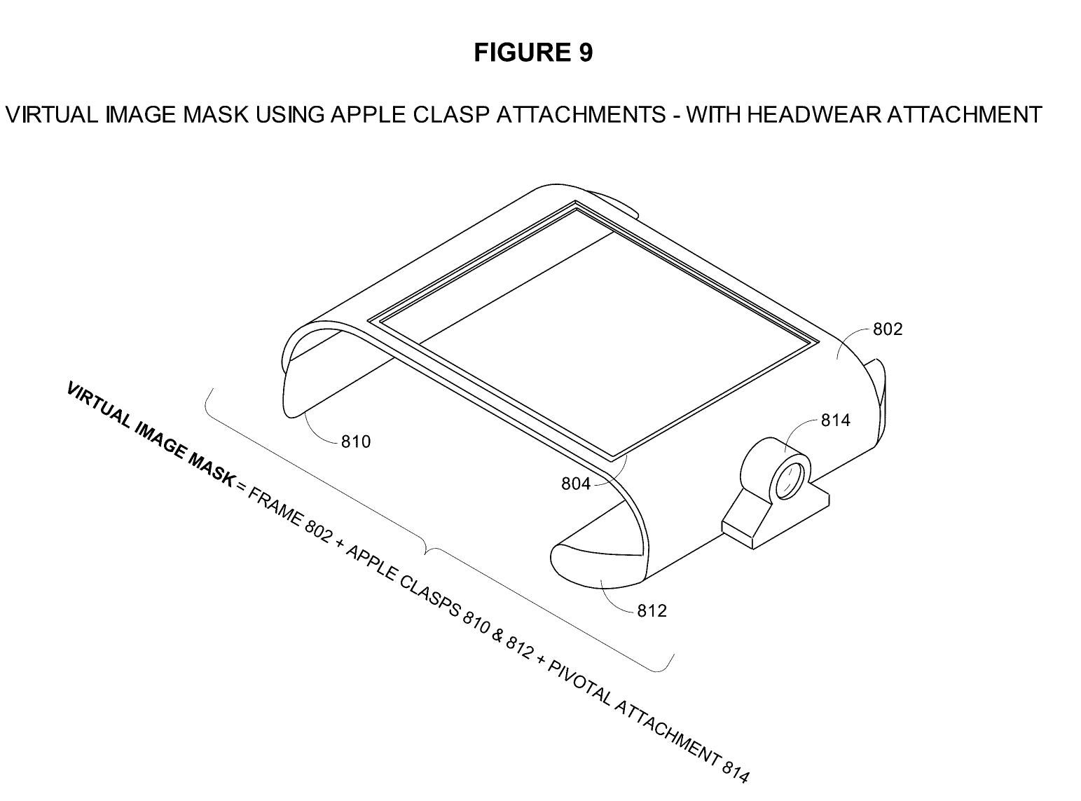

FIG. 9 illustrates a perspective view of said virtual image mask using Apple clasp attachments, with a headwear attachment. The shape of said frame for Apple smartwatch 802, the shape of said receptacle 804 for holding said virtual image means, and the number of said cutouts contained within said frame for Apple smartwatch 802, can differ for different product models of said Apple smartwatch. To secure said frame for Apple smartwatch 802 to said headwear means, said pivotal attachment is used. Said pivotal attachment secures said frame for Apple smartwatch 802 to said headwear means by locking together said male component 816 of said pivotal attachment with said female component 814 of said pivotal attachment, using said locking gasket 820. Said pivotal attachment is integrated with said boom arm 818 on said headwear means. However, other embodiments of said pivotal attachment need not be integrated with said boom arm 818.

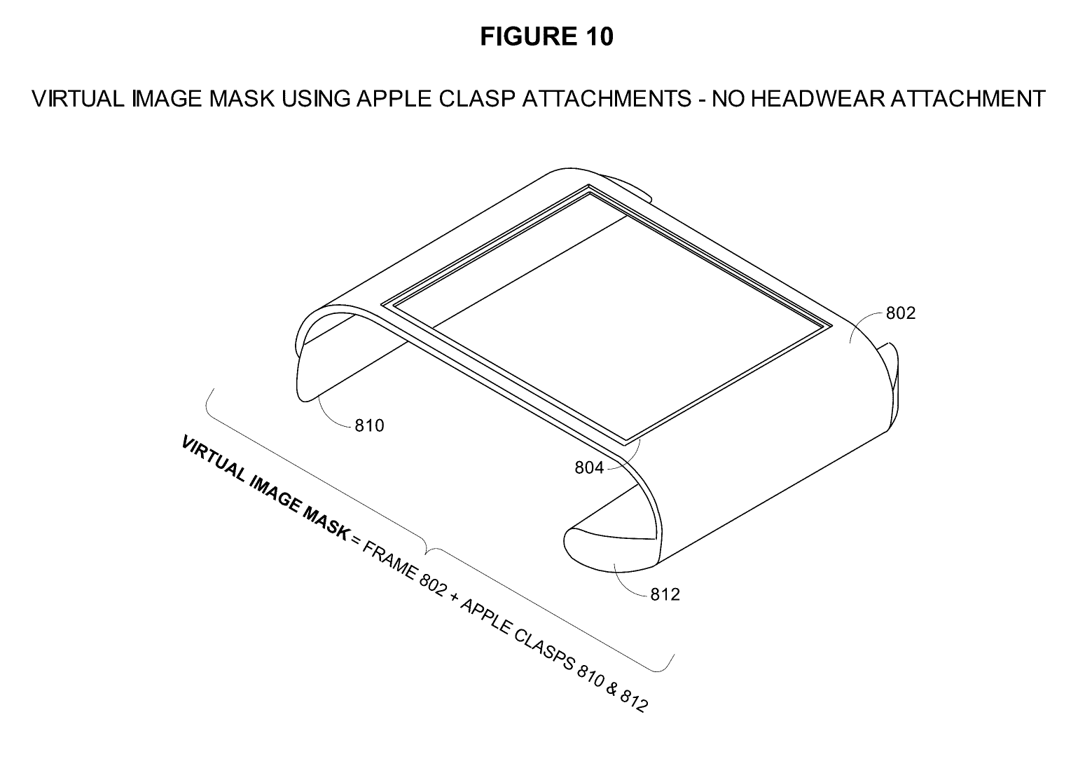

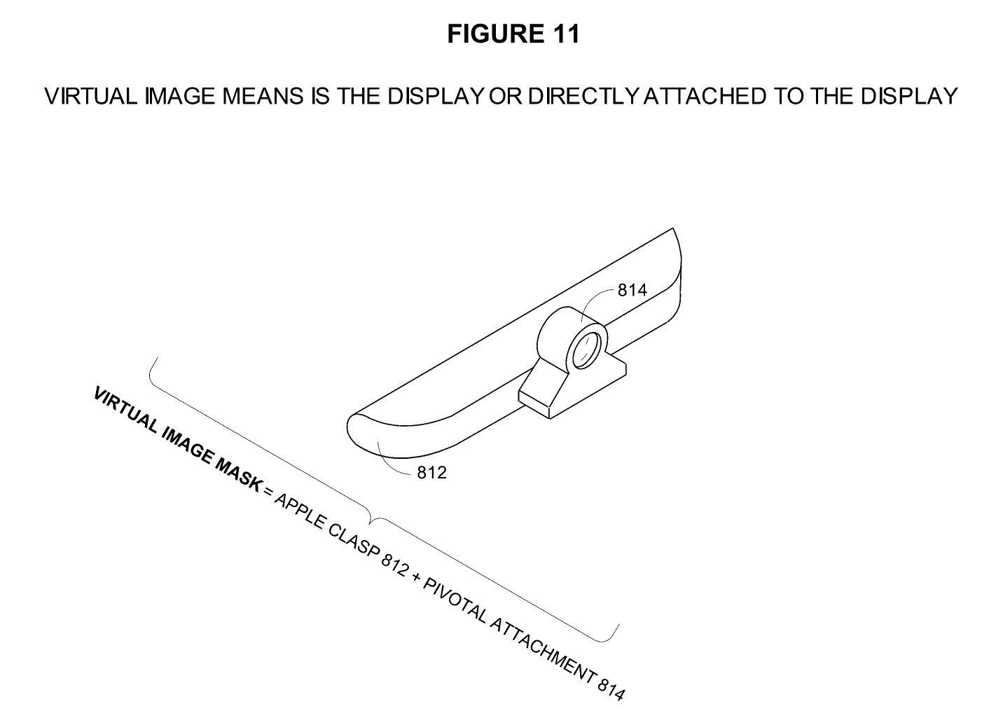

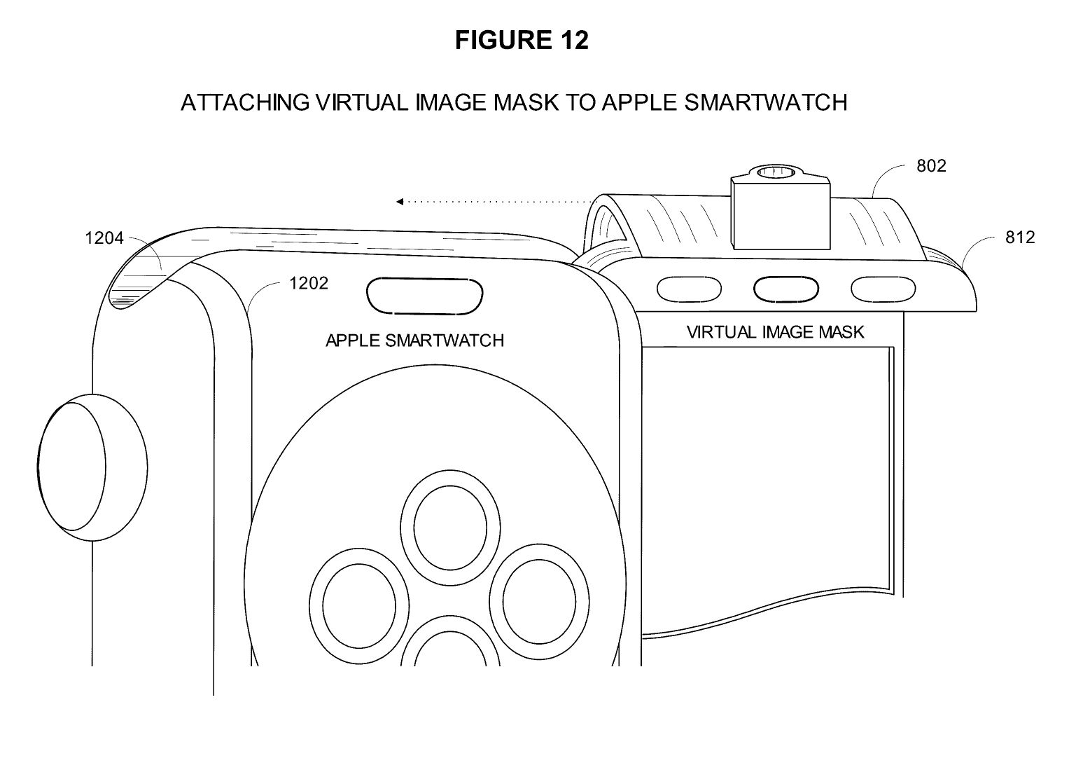

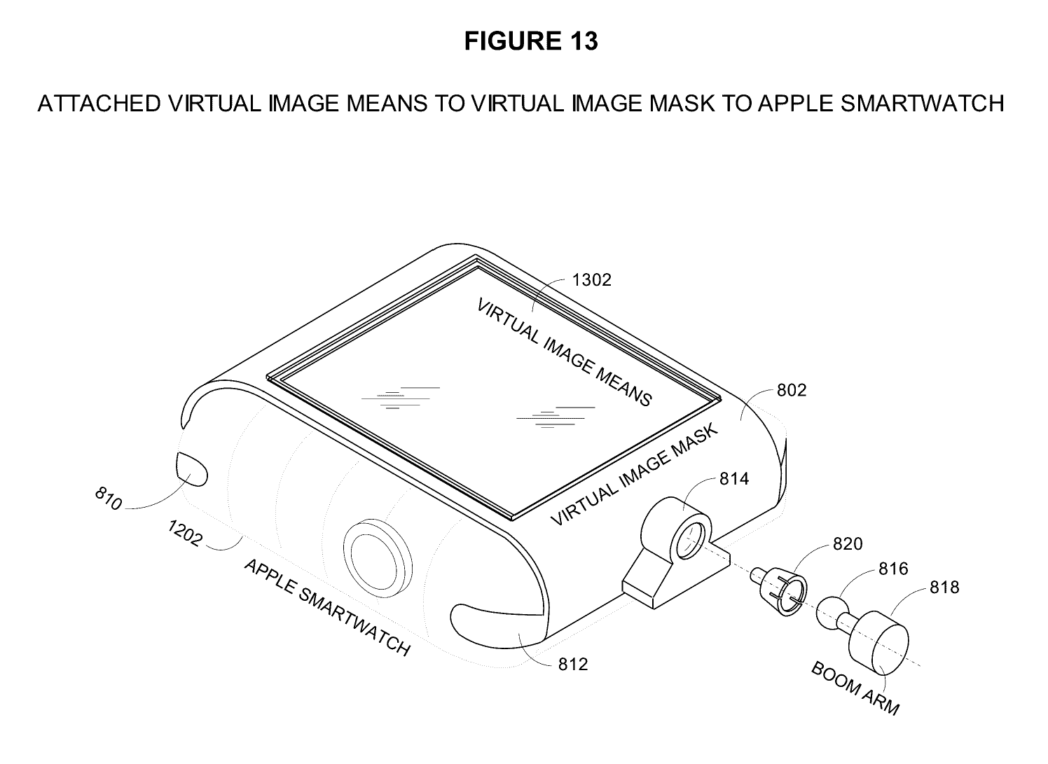

FIG. 10 illustrates a perspective view of said virtual image mask using Apple clasp attachments, with no headwear attachment. FIG. 11 illustrates an embodiment of said virtual image mask in which said smartwatch is said virtual image means, said male Apple clasp attachment 812 is said support means for holding said smartwatch, and said female component 814 of said pivotal attachment both secures said male Apple clasp attachment 812 to said smartwatch and to said headwear means. As illustrated in FIG. 12, to secure said frame for Apple smartwatch 802 to said Apple smartwatch 1202, said male Apple clasp attachment 812 slides into said female Apple clasp attachment 1204. Not shown in FIG. 12, said male Apple clasp attachment 810 slides into said female Apple clasp attachment located at the opposite end of said Apple smartwatch 1202. As illustrated in FIG. 13, said virtual image means 1302, said virtual image mask, and said Apple smartwatch 1202 have been attached. To secure said frame for Apple smartwatch 802 to said headwear means, said locking gasket 820 is used to lock said male component 816 into said female component 814, thus securing said frame for Apple smartwatch 802 to said boom arm 818 on said headwear means. In an additional embodiment, said frame for Apple smartwatch 802 and said boom arm 818 can be integrated together as one single unit, without said pivotal attachment.

Additional embodiments of said virtual image mask can use said attachment means other than said watch pin, said Apple clasp, and said pivotal attachment discussed here. Also, in other embodiments, when said virtual image means is said display means, said attachment means for said display means is a smartwatch case, where said smartwatch case contains the electronic components of said smartwatch.

1. A virtual image mask, comprising:
a. a support means for holding a virtual image means, and
b. an attachment means for securing said support means to a smartwatch, said smartwatch having a display means,
whereby said support means can hold said virtual image means close enough to said display means, so that a magnified virtual image is formed of sufficient size to accommodate use by a human being for viewing and working with software applications developed to run on desktop and laptop computers, when said support means with said smartwatch attached is held near eye.

2. The virtual image mask of claim 1 further including an attachment means for securing said support means to a headwear means.

3. The virtual image mask of claim 1 further including an attachment means for securing said support means to a headwear means, where said headwear means is a nose mounting means, or a head mounting means.

4. The virtual image mask of claim 1 further including an attachment means for securing said support means to a headwear means, wherein said attachment means for securing said support means to said headwear means is a pivotal attachment, a rigid fixed attachment, or an adhesive means.

5. The virtual image mask of claim 1 further including said virtual image means, where said virtual image means is a convex lens, a Fresnel lens, a holographic lens, an eyepiece, or a projection lens system.

6. The virtual image mask of claim 1 wherein said attachment means for securing said support means to a smartwatch is a watch pin, an apple clasp attachment, or an adhesive means.

7. The virtual image mask of claim 1 wherein said virtual image means is said display means on said smartwatch, and said attachment means is the smartwatch case which contains the electronic components of said smartwatch.

8. The virtual image mask of claim 1 wherein said support means is said display means, and said virtual image means is attached directly to said display means using an adhesive means.

9. The virtual image mask of claim 1 wherein said virtual image means is said smartwatch.

10. The virtual image mask of claim 1 wherein said support means is a watch pin, an apple clasp attachment, or an adhesive means, said virtual image means is said display means or attached to said display means on said smartwatch, and said attachment means is a pivotal attachment, a rigid fixed attachment, or an adhesive means that connects with a headwear means.

11. A method for a virtual image mask, comprising:
a. providing a support means for holding a virtual image means, and
b. providing an attachment means for securing said support means to a smartwatch, said smartwatch having a display means,
whereby said support means can hold said virtual image means close enough to said display means, so that a magnified virtual image is formed of sufficient size to accommodate use by a human being for viewing and working with software applications developed to run on desktop and laptop computers, when said support means with said smartwatch attached is held near eye.

12. The virtual image mask of claim 11 further including providing an attachment means for securing said support means to a headwear means.

13. The virtual image mask of claim 11 further including providing an attachment means for securing said support means to a headwear means, where said headwear means is a nose mounting means, or a head mounting means.

14. The virtual image mask of claim 11 further including providing an attachment means for securing said support means to a headwear means, wherein said attachment means for securing said support means to said headwear means is a pivotal attachment, a rigid fixed attachment, or an adhesive means.

15. The virtual image mask of claim 11 further including providing said virtual image means, where said virtual image means is a convex lens, a Fresnel lens, a holographic lens, an eyepiece, or a projection lens system.

16. The virtual image mask of claim 11 wherein said attachment means for securing said support means to a smartwatch is a watch pin, an apple clasp attachment, or an adhesive means.

17. The virtual image mask of claim 11 wherein said virtual image means is said display means on said smartwatch, and said attachment means is the smartwatch case which contains the electronic components of said smartwatch.

18. The virtual image mask of claim 11 wherein said support means is said display means, and said virtual image means is attached directly to said display means using an adhesive means.

19. The virtual image mask of claim 11 wherein said virtual image means is said smartwatch.

20. The virtual image mask of claim 11 wherein said support means is a watch pin, an apple clasp attachment, or an adhesive means, said virtual image means is said display means or attached to said display means on said smartwatch, and said attachment means is a pivotal attachment, a rigid fixed attachment, or an adhesive means that connects with a headwear means.
